(19) United States
(12) Patent Application Publication
(10) Pub. No.: US 2016/0155588 A1
(43) Pub. Date: Jun. 2, 2016

(54) TEMPERATURE SWITCH

(71) Applicant: Yu-Kang YANG, Tainan City (TW)

(72) Inventor: Yu-Kang YANG, Tainan City (TW)

(21) Appl. No.: 14/703,232

(22) Filed: May 4, 2015

(30) Foreign Application Priority Data
Nov. 28, 2014 (TW) 103221170

(51) Int. Cl. H01H 37/48; H01H 37/04

(52) U.S. Cl. CPC H01H 37/48; H01H 37/04; H01H 2231/012

(57) ABSTRACT

A temperature switch includes a temperature control mechanism for switching between conducting and non-conducting states, and a conducting mechanism. The conducting mechanism includes first and second conducting units and a safety unit. The first conducting unit includes a first conducting piece and a first connecting piece electrically connected to one of a pair of wires. The second conducting unit is electrically connected to the other one of the wires. The safety unit includes a conductive resilient bracket having two first abutting walls and two temperature-dependent deformable components biasing the first abutting walls to contact respectively the first conducting piece and the first connecting piece.

### CROSS-REFERENCE TO RELATED APPLICATION

This application claims priority of Taiwanese Application No. 103221170, filed on Nov. 28, 2014.

### FIELD

The disclosure relates to a switch, and more particularly to a temperature switch that is deformable to cut off power supply of an electric device when an abnormal temperature condition occurs.

### BACKGROUND

An electric heating appliance, such as a water dispenser, a coffee maker, an electrical iron, a hairdryer, etc., usually includes an internal temperature switch and a thermal fuse to improve safety. Referring to FIGS. 1 to 3, Taiwanese Utility Model Patent No. M472941 discloses a temperature switch 1 that is adapted to abut against a heater 11 and to electrically interconnect two wires 12. The temperature switch 1 includes a base 13 that is formed with an accommodating chamber 130, a conducting mechanism 14 that is mounted on the base 13 and that is electrically connected to the wires 12, and a temperature control mechanism 15 that is mounted on the base 13 and that abuts against the heater 11.

The conducting mechanism 14 includes first and second conducting units 141, 142 respectively connected to the wires 12, and a safety unit 143 mounted in the base 13 for controlling the first conducting unit 141 to switch between conducting and non-conducting states. The first conducting unit 141 includes a connecting piece 144 that is electrically connected to one of the wires 12, and a conducting piece 145 that is disposed in the accommodating chamber 130 and that is separate from the connecting piece 144. The safety unit 143 includes a conductive resilient bracket 147 and a temperature-dependent deformable component 148. The conductive resilient bracket 147 includes two abutting walls 146. The temperature-dependent deformable component 148 is disposed between and supports the abutting walls 146. The temperature control mechanism 15 abuts against the heater 11, so that when the temperature of the heater 11 exceeds a temperature threshold, the temperature control mechanism 15 may separate the first and second conducting units 141, 142 to cut off conductivity.

During use, if the temperature control mechanism 15 fails to separate the first and second conducting units 141, 142 when the temperature is abnormally high, electric currents will unstoppably circulate between the wires 12 and the environmental temperature tends to increase. When the temperature-dependent deformable component 148 of the safety unit 143 deforms due to the abnormally high environmental temperature, the abutting walls 146 of the conductive resilient bracket 147 will restore to switch from a conducting state as shown in the dotted lines in FIG. 3, to a non-conducting state as shown in solid lines in FIG. 3. An additional safety unit may be required for improving safety in use for the conventional electric heating appliance, but internal space for receiving the safety unit may not be available, production costs may be increased, and the manufacturing process may be complicated.

### SUMMARY

According to the disclosure, there is provided a temperature switch adapted to electrically interconnect two wires. The temperature switch includes abase, a conducting mechanism and a temperature control mechanism. The temperature control mechanism switches the temperature switch between conducting and non-conducting states. The conducting mechanism is mounted on the base, and includes a first conducting unit, a second conducting unit and a safety unit.

The first conducting unit includes a first conducting piece, and a first connecting piece spaced apart from the first conducting piece and adapted to be electrically connected to one of the wires.

The second conducting unit is adapted to be electrically connected to the other one of the wires.

The safety unit includes a conductive resilient bracket and two temperature-dependent deformable components. The conductive resilient bracket has two first abutting walls that are spaced apart from each other in an axial direction. The temperature-dependent deformable components are aligned with each other in the axial direction, are connected respectively to the first abutting walls, and bias the first abutting walls to contact respectively the first conducting piece and the first connecting piece when the temperature switch is in the conducting state. Each of the temperature-dependent deformable components is deformable upon exceeding a temperature threshold to respectively separate the first abutting walls from the first conducting piece and the first connecting piece to thereby switch the temperature switch from the conducting state to the non-conducting state.

### BRIEF DESCRIPTION OF THE DRAWINGS

Other features and advantages of the present disclosure will become apparent in the following detailed description of the embodiments with reference to the accompanying drawings, of which:

FIG. 1 is an exploded perspective view of a conventional temperature switch disclosed in Taiwanese Utility Model No. M472941;

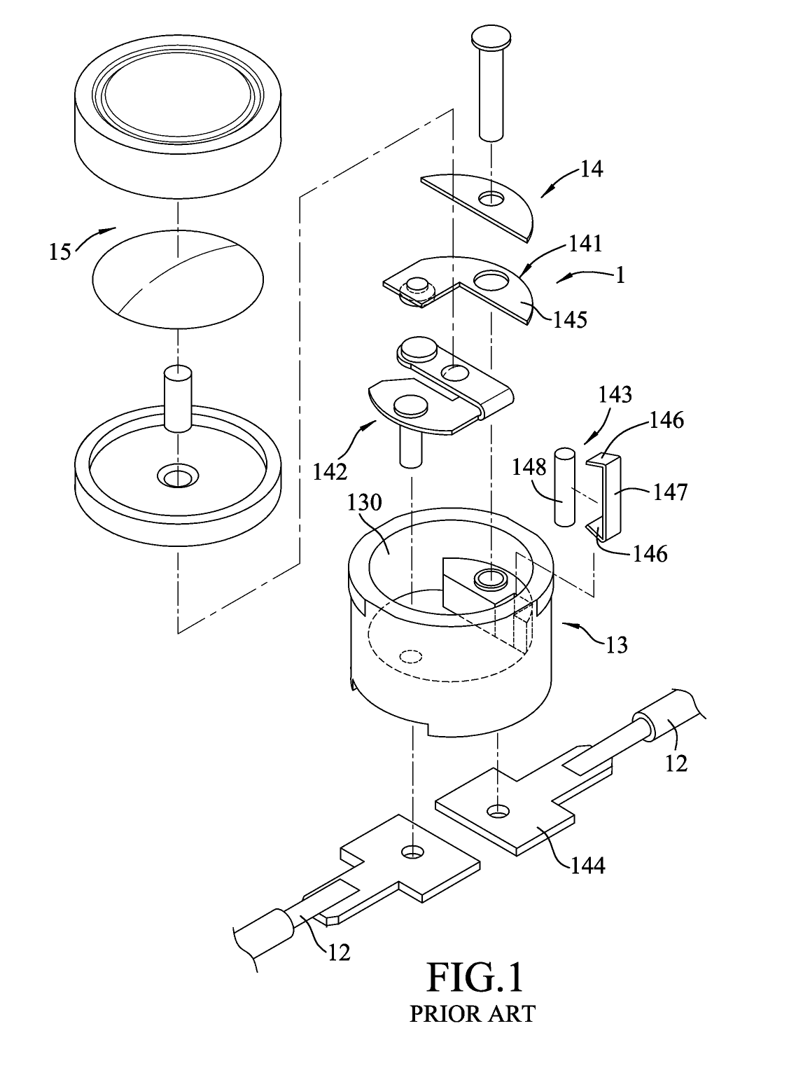

FIG. 2 is a sectional view for illustrating the relationship between a conducting mechanism and a temperature control mechanism of the conventional temperature switch;

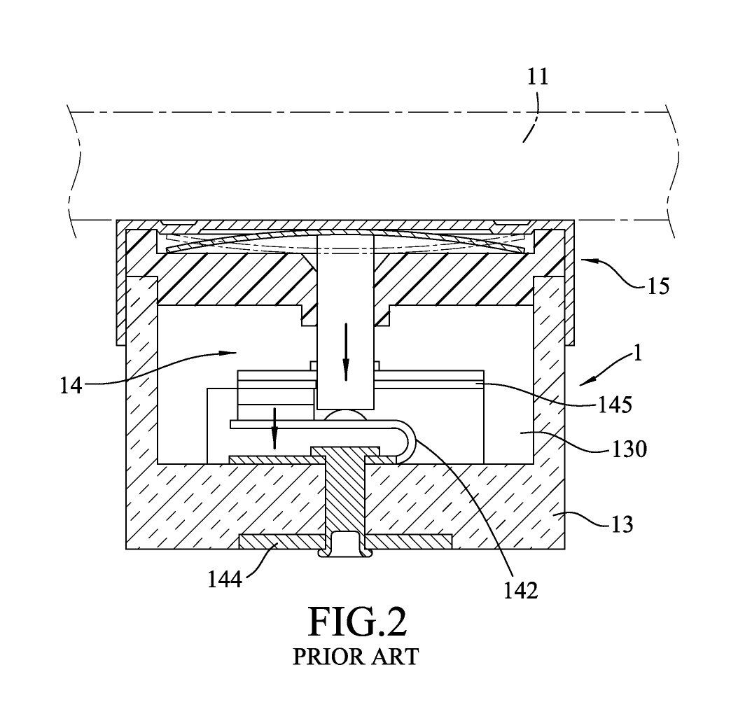

FIG. 3 is a sectional view for illustrating a safety unit of the conventional temperature switch;

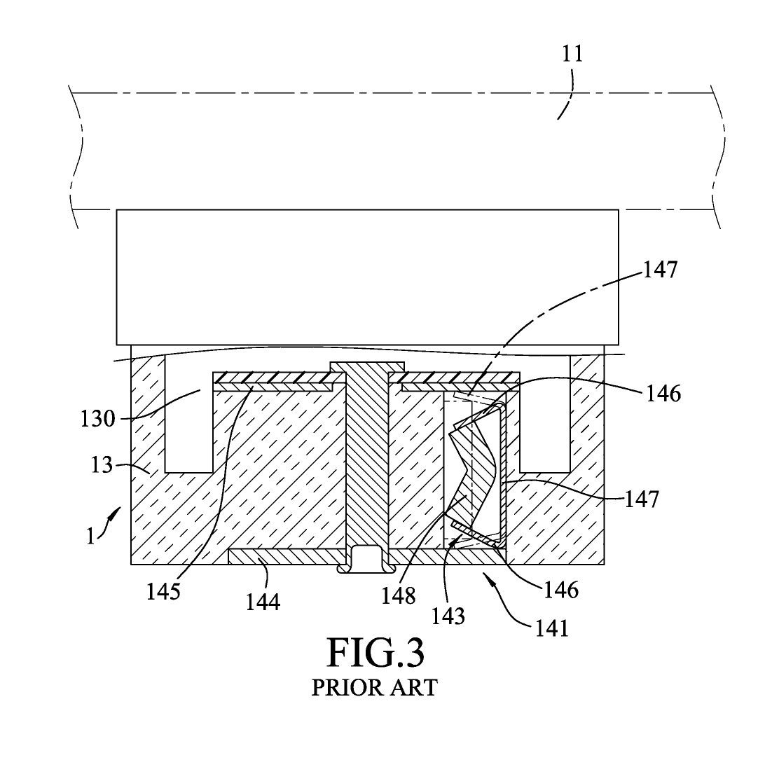

FIG. 4 is an exploded perspective view of an embodiment of a temperature switch according to the present disclosure;

FIG. 5 is a top view of the embodiment;

FIG. 6 is an exploded side view for illustrating a safety unit of the embodiment;

FIG. 7 is a sectional view of the embodiment taken along line VII-VII of FIG. 5;

FIG. 8 is a sectional view of the embodiment in a conducting state, taken along line VIII-VIII of FIG. 5; and

FIG. 9 is a sectional view of the embodiment in a non-conducting state, taken along line VIII-VIII of FIG. 5.

### DETAILED DESCRIPTION

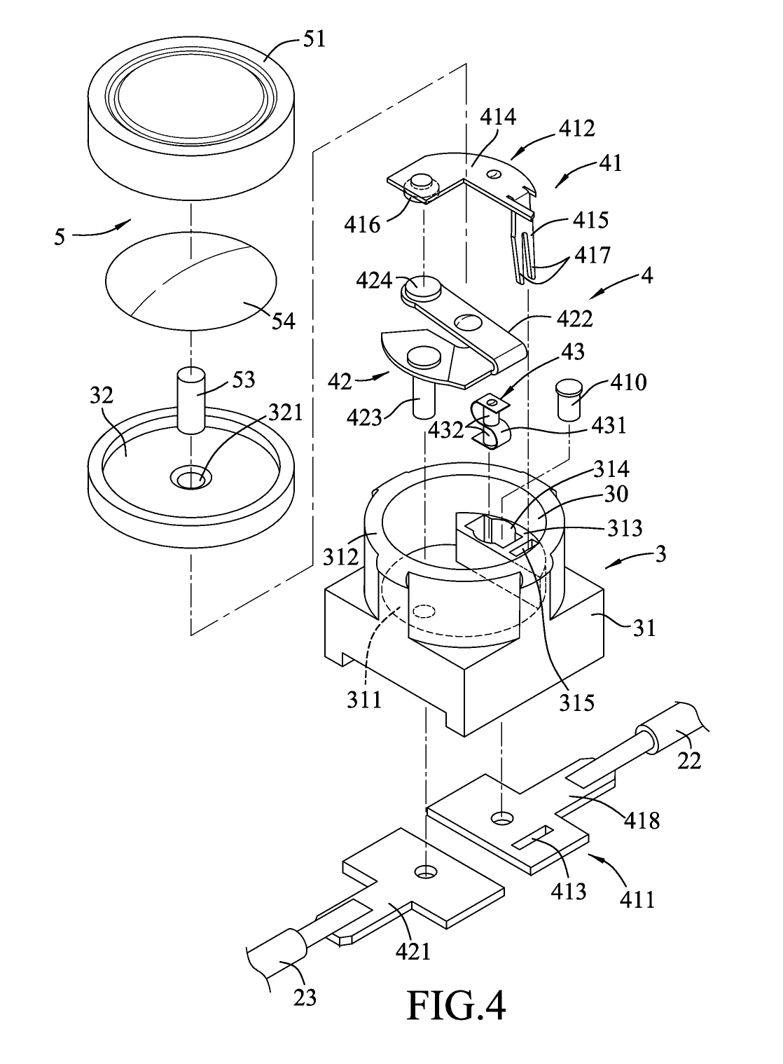

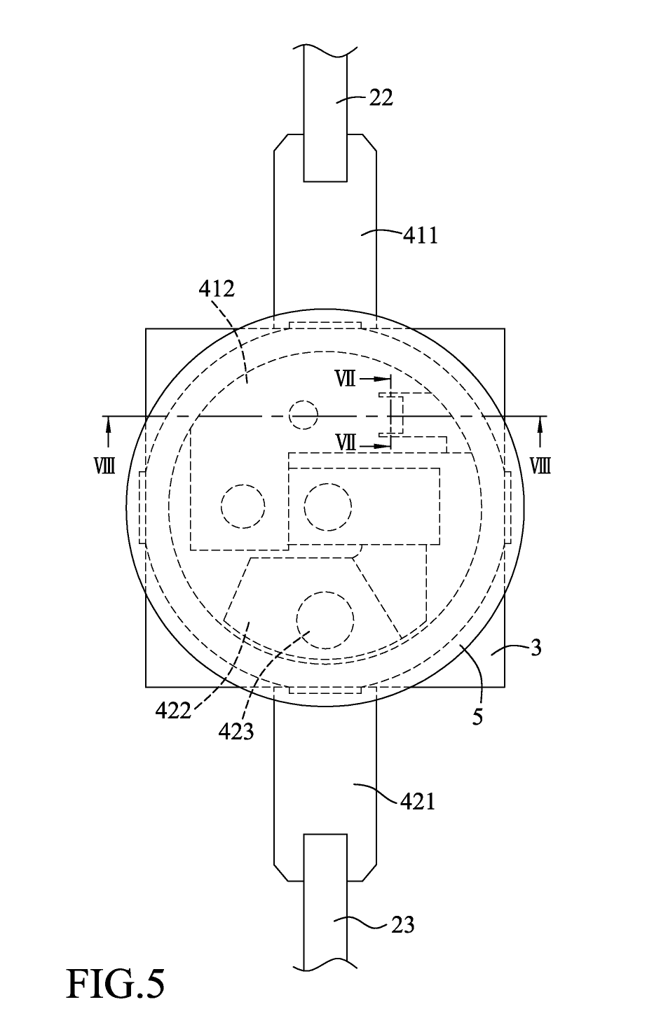

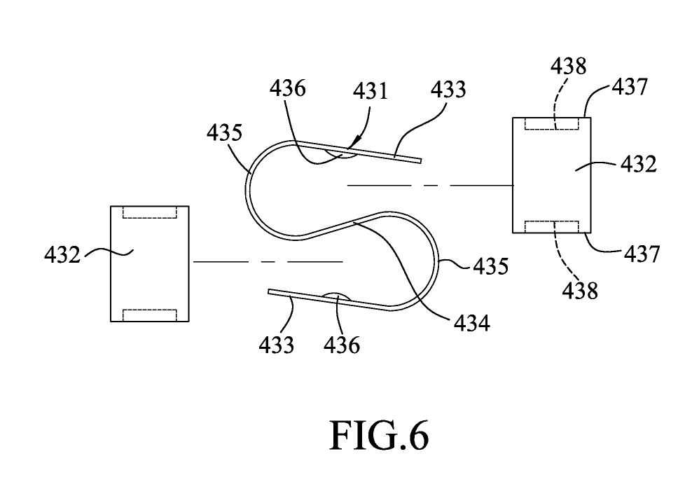

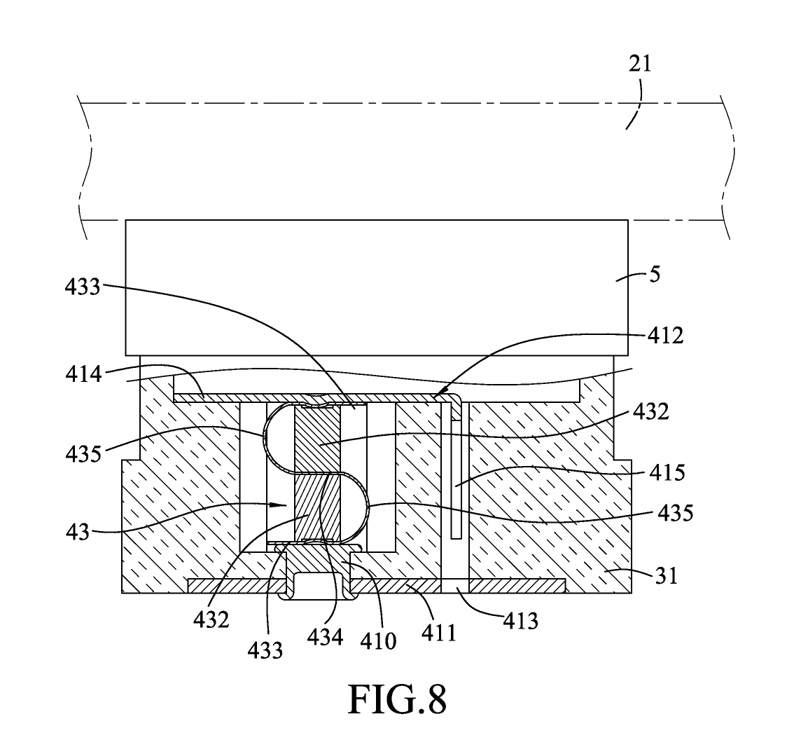

Referring to FIGS. 4 to 6, an embodiment of a temperature switch according to the disclosure is switchable between conducting and non-conducting states, abuts against a heater 21 (shown in FIG. 8), and interconnects two wires 22, 23. The temperature switch includes a base 3, a conducting mechanism 4 mounted on the base 3, and a temperature control mechanism 5 mounted on the base 3 and abutting against the heater 21.

The base 3 includes a base body 31, and a cap body 32 connected to the base body 31 and cooperating with the base body 31 to define an accommodating chamber 30 therebetween. The base body 31 may be made of a ceramic material or a heat-tolerable and insulating plastic material. The base body 31 has a base wall 311, a surrounding wall 312, a platform 313, a mounting hole 314 and an insert hole 315. The surrounding wall 312 extends from a periphery of the base wall 311 and surrounds the accommodating chamber 30. The platform 313 extends from the base wall 311 into the accommodating chamber 30, and is connected to the surrounding wall 312. The mounting hole 314 and the insert hole 315 extend through the platform 313 and the base wall 311. The cap body 32 is centrally formed with a plug-limiting hole 321.

The conducting mechanism 4 includes first and second conducting units 41, 42, and a safety unit 43 mounted in the mounted hole 314 of the base 3. The first conducting unit 41 includes a first connecting piece 411 and a first conducting piece 412. The first connecting piece 411 is spaced apart from the first conducting piece 412 and is adapted to be electrically connected to one of the wires 22. The first conducting piece 412 is disposed in the accommodating chamber 30. The first connecting piece 411 includes a plate body 418, and a conducting rod 410 for coupling the plate body 418 to a bottom side of the base wall 311. The plate body 418 is formed with a through hole 413 that is registered with the insert hole 315 in the base body 31. The first conducting piece 412 has a fixing portion 414, an insert portion 415 and a first contact portion 416. The fixing portion 414 is connected to a top side of the platform 313, and spaced parallel to the plate body 418 of the first connecting piece 411. The insert portion 415 protrudes from the fixing portion 414 toward the insert hole 315 in the base 3 and is formed with two pins 417 to engage therewith. The first contact portion 416 protrudes from the fixing portion 414 so as to be suspended.

The second conducting unit 42 includes a second connecting piece 421, a second conducting piece 422 and a connecting rod 423. The second connecting piece 421 is disposed below the base wall 311 and is adapted to be connected to the other one of the wires 23. The second conducting piece 422 is accommodated in the accommodating chamber 30 of the base 3. The connecting rod 423 extends through the base wall 311 and is electrically connected to the second connecting piece 421 and the second conducting piece 422. The second conducting piece 422 includes a second contact portion 424 that removably contacts the first contact portion 416 of the first conducting piece 412 when the temperature switch is in the conducting state.

The safety unit 43 includes a conductive resilient bracket 431 and two temperature-dependent deformable components 432. The conductive resilient bracket 431 may be made of a conductive material, is substantially S-shaped, and has two first abutting walls 433, a second abutting wall 434, and two linking walls 435. The first abutting walls 433 are spaced apart from each other in an axial direction. The second abutting wall 434 is disposed between the first abutting walls 433. Each of the linking walls 435 links the second abutting wall 434 and a respective one of the first abutting walls 433. The temperature-dependent deformable components 432 may have elongated cylindrical shapes, are aligned with each other in the axial direction, and are connected respectively to the first abutting walls 433. The temperature-dependent deformable components 432 bias the first abutting walls 433 to respectively contact the first conducting piece 412 and the first connecting piece 411 when the temperature switch is in the conducting state. Each of the temperature-dependent deformable components 432 has two end surfaces 437 and two recesses 438. The end surfaces 437 of each of the temperature-dependent deformable components 432 are spaced apart from each other in the axial direction, and respectively abut against the second abutting wall 434 and the respective one of the first abutting walls 433 when the temperature switch is in the conducting state. Each of the temperature-dependent deformable components 432 is deformable upon exceeding a temperature threshold to respectively separate the first abutting walls 433 from the first conducting piece 412 and the first connecting piece 411 to thereby switch the temperature switch from the conducting state to the non-conducting state. The recesses 438 are respectively formed in the end surfaces thereof. Each of the first abutting walls 433 includes a protrusion 436 protruding toward the second abutting wall 434 and into one of the recesses 438 of a corresponding one of the temperature-dependent deformable components 432.

The temperature control mechanism 5 controls switching of the temperature switch between the conducting and non-conducting states, and includes a temperature-sensitive cover 51 that may be made of a thermally conductive material and that is connected to the base 3, a control rod 53 that is inserted into the plug-limiting hole 321 of the cap body 32 and that may be made of a thermally insulating material, and a temperature-sensitive member 54 that is deformable when exposed to a high temperature environment and that is mounted between the temperature-sensitive cover 51 and the cap body 32.

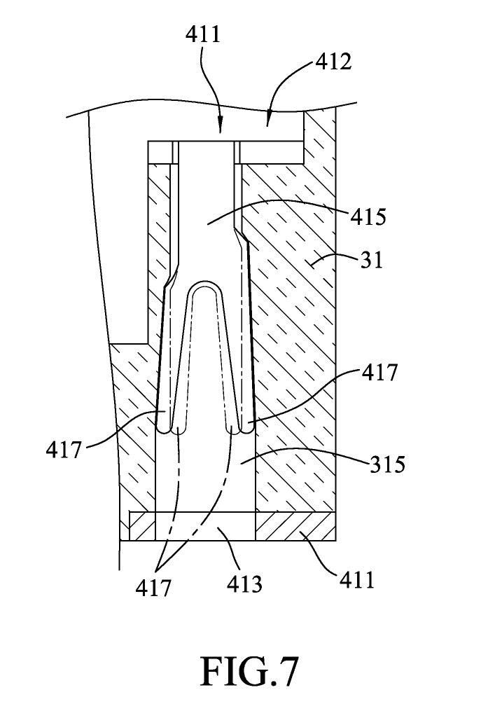

Referring to FIGS. 4, 6, 7 and 8, when assembling the temperature switch, the safety unit 43 is mounted in the mounting hole 314 of the base 3, and the temperature-dependent deformable components 432 are aligned with each other in the axial direction where each are disposed between the second abutting wall 434 and the corresponding one of the first abutting walls 433, so as to increase the height of the conductive resilient bracket 431. The insert portion 415 of the first conducting piece 412 is inserted into the insert hole 315 in the body 3, and the pins 417 of the first conducting piece 412 are forced to laterally expand by an appropriate tool extending through the through hole 413 of the first connecting piece 411 and the insert hole 315 so that the first conducting piece 412 is secured on the base 3. Finally, the second conducting unit 42 and the temperature control mechanism 5 are mounted to complete assembly of the temperature switch, which will be in the conducting state as shown in FIG. 8.

In the conducting state, the temperature-sensitive member 54 has an arcuate shape, and the first contact portion 416 of the first conducting piece 412 contacts the second contact portion 424 of the second conducting piece 422. The conductive resilient bracket 431 with the increased height allows the first abutting walls 433 to respectively abut against the first connecting piece 411 and the first conducting piece 412. At this time, the electrical current flows through between the wires 22, 23 via the conducting mechanism 4.

During use, if the temperature of the heater 21 exceeds a temperature threshold, the temperature-sensitive member 54 of the temperature control mechanism 5 tends to deform, driving the control rod 53 to push the second contact portion 424 of the second conducting piece 422 away from the first contact portion 416 of the first conducting piece 412 so as to cut off electrical connection therebetween, i.e., the temperature switch is switched to the non-conducting state. When the temperature of the heater 21 returns to normal (no more exceeds the temperature threshold), the temperature-sensitive member 54 will return to its original shape and the temperature switch returns to the conducting state.

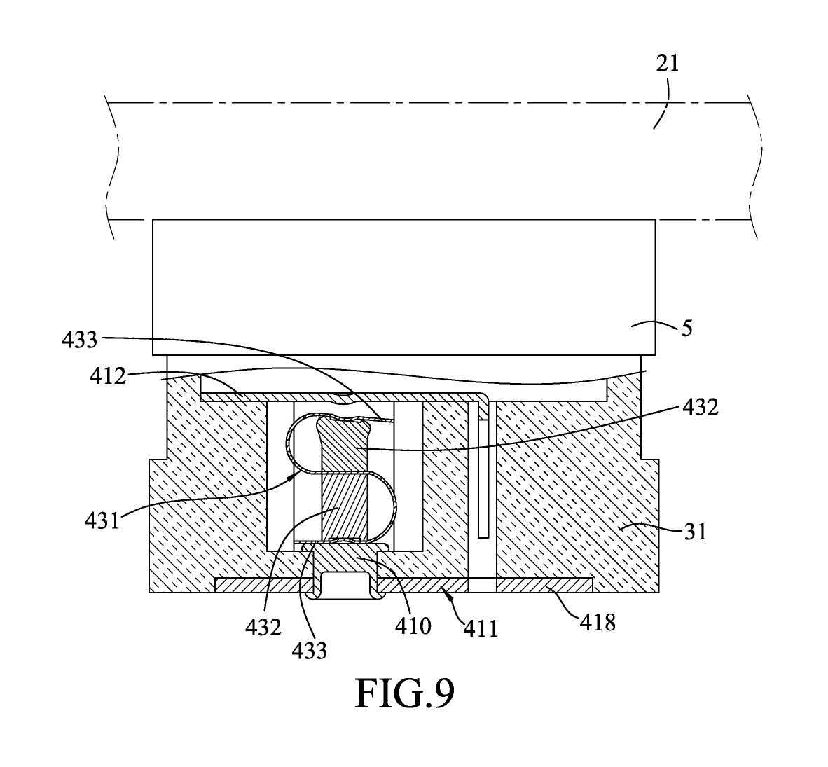

Referring to FIGS. 4, 8 and 9, when the temperature of the heater 21 exceeds the temperature threshold and the temperature-sensitive member 54 malfunctions and fails to deform to cut off conductivity, or that the first contact portion 416 of the first conducting piece 412 is abnormally stuck to the second contact portion 424 of the second conducting piece 422, i.e., the first conducting piece 412 and the second conducting piece 422 are unable to be separated from each other, the electrical current tends to continuously pass through the wires 22, 23. Thereby, the environmental temperature is abnormally increased. When the increase in the environmental temperature results in deformation of the temperature-dependent deformable components 432, the conductive resilient bracket 431 supported by the temperature-dependent deformable components 432 tends to be lowered, and one of the first abutting walls 433 stops biasing the respective one of the first conducting piece 412 and the first connecting piece 411. At this moment, the temperature switch is switched from the conducting state as shown in FIG. 8 to the non-conducting state as shown in FIG. 9. In this embodiment, as long as one of the temperature-dependent deformable components 432 deforms, the temperature switch will be switched from the conducting state to the non-conducting state.

While the present disclosure has been described in connection with what is considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. A temperature switch adapted to electrically interconnect two wires comprising:
a base;
a temperature control mechanism for switching said temperature switch between conducting and non-conducting states; and
a conducting mechanism mounted on said base, and including
a first conducting unit that includes a first conducting piece, and a first connecting piece spaced apart from said first conducting piece and adapted to be electrically connected to one of the wires,
a second conducting unit that is adapted to be electrically connected to the other one of the wires, and
a safety unit that includes
a conductive resilient bracket having two first abutting walls that are spaced apart from each other in an axial direction, and
two temperature-dependent deformable components aligned with each other in the axial direction, connected respectively to said first abutting walls, and biasing said first abutting walls to contact respectively said first conducting piece and said first connecting piece when said temperature switch is in the conducting state, each of said temperature-dependent deformable components being deformable upon exceeding a temperature threshold to respectively separate said first abutting walls from said first conducting piece and said first connecting piece to thereby switch said temperature switch from the conducting state to the non-conducting state.

2. The temperature switch as claimed in claim 1, wherein:
said conductive resilient bracket is substantially S-shaped, and further includes a second abutting wall that is disposed between said first abutting walls, and two linking walls, each of said linking walls linking said second abutting wall and a respective one of said first abutting walls; and
each of said temperature-dependent deformable components has two end surfaces that are spaced apart from each other in the axial direction, and that respectively abut against said second abutting wall and the respective one of said first abutting walls when said temperature switch is in the conducting state.

3. The temperature switch as claimed in claim 2, wherein:
each of said temperature-dependent deformable components further has two recesses respectively formed in said end surfaces thereof; and
each of said first abutting walls of said conductive resilient bracket includes a protrusion protruding toward said second abutting wall and into one of said recesses of a corresponding one of said temperature-dependent deformable components.

4. The temperature switch as claimed in claim 3, wherein said base includes a base body, and a cap body connected to said base body and cooperating with said base body to define an accommodating chamber therebetween, said base body having a base wall, a surrounding wall that extends from a periphery of said base wall and that surrounds said accommodating chamber, a platform that extends from said base wall into said accommodating chamber and that is connected to said surrounding wall, and a mounting hole that extends through said platform and said base wall, said safety unit being mounted in said mounting hole.

5. The temperature switch as claimed in claim 4, wherein said base body of said base further has an insert hole extending through said platform and said base wall, said first conducting piece of said conducting mechanism having a fixing portion that is connected to a top side of said platform, and an insert portion that engages said insert hole of said base.

6. The temperature switch as claimed in claim 5, wherein:
said first connecting piece further has a first contact portion protruding from said fixing portion so that said first contact portion is suspended; and
said second conducting unit includes a second connecting piece disposed below said base wall, a second conducting piece accommodated in said accommodating chamber of said base, and a connecting rod extending through said base wall and electrically connected to said second connecting piece and said second conducting piece, said second conducting piece including a second contact portion that removably contacts said first contact portion when said temperature switch is in the conducting state.

7. The temperature switch as claimed in claim 1, wherein said base includes a base body, and a cap body connected to said base body and cooperating with said base body to define an accommodating chamber therebetween, said base body having a base wall, a surrounding wall that extends from a periphery of said base wall and that surrounds said accommodating chamber, a platform that extends from said base wall into said accommodating chamber and that is connected to said surrounding wall, and a mounting hole that extends through said platform and said base wall, said safety unit being mounted in said mounting hole.
